(19) United States
(12) Patent Application Publication
(10) Pub. No.: US 2006/0254102 A1
(43) Pub. Date: Nov. 16, 2006

(54) Information Poster

(76) Inventor: Denis Borisovich Mayants, Moscow (RU)

Correspondence Address: HOUSTON ELISEEVA, 4 MILITIA DRIVE, SUITE 4, LEXINGTON, MA, 02421, US

(21) Appl. No.: 11/425,716

(22) Filed: Jun. 22, 2006

Related U.S. Application Data
(63) Continuation of application No. PCT/RU04/00496, filed on Dec. 10, 2004.

(30) Foreign Application Priority Data
Dec. 25, 2003 (RU) RU2003137214

(51) Int. Cl. G09F 7/00; G09F 3/04

(52) U.S. Cl. 40/602; 40/447

(57) ABSTRACT

The invention relates to advertising constructions, in particular to advertising and information posters, stands, panels and boards and can be used in the form of advertising means. The inventive information poster comprises image elements and a base to which said image elements are fixed in such a way that they change the position thereof by wind force. The base can be embodied in the form of a grid and the image elements are disposed in such a way that they modify the position thereof in horizontal, vertical and tilted planes. Said invention makes it possible to reduce the wind load applied mass % to the poster and to use large-sized posters on an outdoor space.

### RELATED APPLICATIONS

This application is a Continuation of PCT application serial number PCT/RU2004/000496 filed on Dec. 10, 2004 which in turn claims priority to Russian application serial number RU2003137214 filed on Dec. 25, 2003 both of which are incorporated herein by reference in their entirety.

### FIELD OF THE INVENTION

The invention relates to advertising constructions, in particular to advertising and information posters, stands, panels and boards and can be used in the form of advertising means.

### BACKGROUND OF THE INVENTION

An advertising panel is known comprising support elements to which an advertising panel is fixed having images of different advertising or information messages, wherein the advertising panel is fixed on the support elements and configured to change its position under wind load (GB, patent No. 2308913, 09.07.1007).

An information stand is known comprising a support and image elements constituting the stand. The latter are configured to turn under wind load to prevent the stand from breaking. Return to the initial position occurs due to counterweights (EP, patent No. 1122706, 08.08.2001).

Also an information poster is known including a base with image elements installed to change their position in relation to the base under wind load (DE, patent No. 2622356, 02.12.1976).

A disadvantage of the known construction of the information stand is impossibility to provide large-sized advertising constructions installed on an outdoor space.

### SUMMARY OF THE INVENTION

The object of the invention is to provide a construction that ensures reduction of wind load on a poster.

This problem is resolved by providing an information poster including a base with image elements adjusted to change the position thereof in relation to the base under wind load, the base being made in the form of a grid, wherein the image elements are disposed on the grid in such a way that they modify the position thereof in horizontal, vertical and tilted planes.

As well as by making the image elements from the grid material.

### BRIEF DESCRIPTION OF THE DRAWINGS

The invention is illustrated by drawings, wherein

FIG. 1 schematically shows the general view of the information poster,

FIG. 2 shown assembly 1 of FIG. 1,

FIG. 3 shows section A-A in FIG. 2,

FIG. 4 shows section A-A in FIG. 2 (second variant),

FIG. 5 shows assembly 1 of FIG. 1 (second variant),

FIG. 6 shows section B-B of FIG. 5.

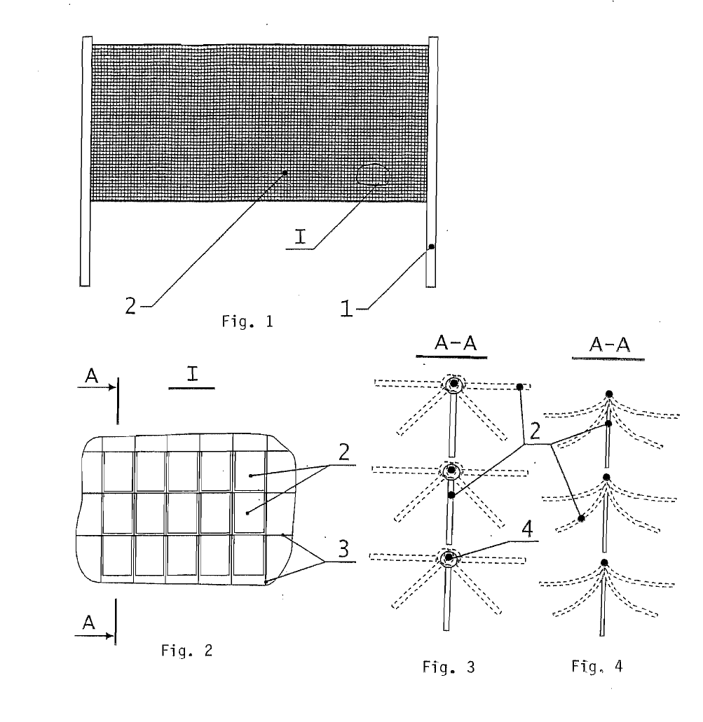

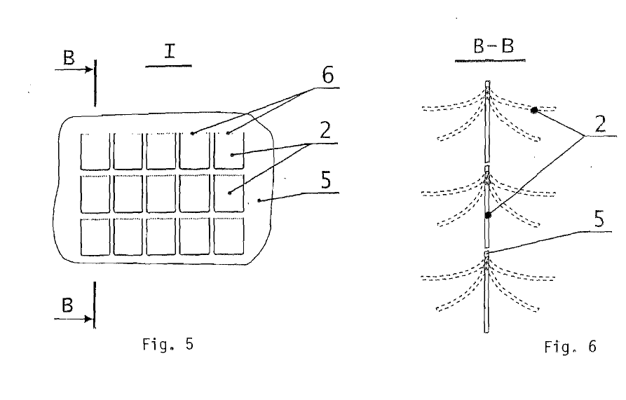

### DETAILED DESCRIPTION OF THE PREFERRED EMBODIMENTS

The information poster consists of support 1, image elements 2 fixed to the base 3. The latter is formed as a grid to elements 4 of which image elements 2 are fixed in such a way that they can modify the position thereof under wind load. The image elements 2 can rotate about elements 4 of the grid, or flex away. Furthermore, the base may be made in the form of a canvas 5 wherein the image elements 2 are formed in slits that also are capable of changing their position under wind load. Return of the image elements to the initial position is due to gravity of the image elements and/or action of elastic forces.

Image elements 2 may be fixed to elements 4 of the grid on horizontal axes, vertical axes or tilted axes depending on construction of the grid. Thus, the image elements have the possibility to modify the position in horizontal, vertical or tilted planes. Similar slits may be formed on the canvas 5 so that side 6 of an image element not subjected to slitting is disposed horizontally, vertically or in tilted way.

The information poster positioned on the open space is exposed to wind load. But due to the fact that the poster is formed from the separate image elements 2 fixed to the base 3 and configured to change the position of these elements under wind load, this wind load on the poster is reduced, its stability is enhanced and the possibility is provided to use large-sized posters on an outdoor space.

What is claimed is:

1. An information poster comprising a base having image elements fixed thereto in such a way that they can change the position thereof in relation to the base under wind load, characterised in that the based is formed as a grid, wherein the image elements are fixed to the grid so as to be able to change the position in horizontal, vertical or tilted planes.

2. The poster according to claim 1, characterised in that the image elements are made from the grid material.
